(19) United States
(12) Patent Application Publication
(10) Pub. No.: US 2014/0361598 A1
(43) Pub. Date: Dec. 11, 2014

(54) Road CRAB

(71) Applicants: David Owen Greenlaw, Quitman, TX (US); Melody Denise Greenlaw, Quitman, TX (US)

(72) Inventors: David Owen Greenlaw, Quitman, TX (US); Melody Denise Greenlaw, Quitman, TX (US)

(73) Assignees: David Owen Greenlaw, Quitman, TX (US); Melony Denise Greenlaw, Quitman, TX (US)

(21) Appl. No.: 13/914,740

(22) Filed: Jun. 11, 2013

(51) Int. Cl. E01C 23/082; B60D 1/07

(52) U.S. Cl. CPC E01C 23/082; B60D 1/07
USPC 299/36.1; 280/416.1

(57) ABSTRACT

The Road CRAB is road construction equipment used to remove road reflectors. This machine includes a manually operated blade that moves up and down, two hitches, one off set to the driver's side, and one that raises the front to wheels off the ground. It does not have a motor and is towed with a standard ball hitch on any work truck. When in use it has all four wheels on the ground with an operator (person) raising and lowering the blade with a handle. When being towed to and from job sites the travel hitch raises the front two wheels off the ground so it is easily towed on the back two wheels.

The Road CRAB is one unit comprised of a four-wheeled base, with a mechanical blade moving up and down under the base of the machine. The blade is raised so there is no contact with the pavement below, and then lowered just before coming into contact with the marker (TRPM). The blade is designed to be manually or automatically raised and lowered with the handle that comes up through the trailer floor from the blade unit.

The blades function is to slice off pavement markers (TRPM) like a knife while being towed slowly down the road. The movement of the machine forward pulls the blade under the maker (TRPM) separating it from the pavement.

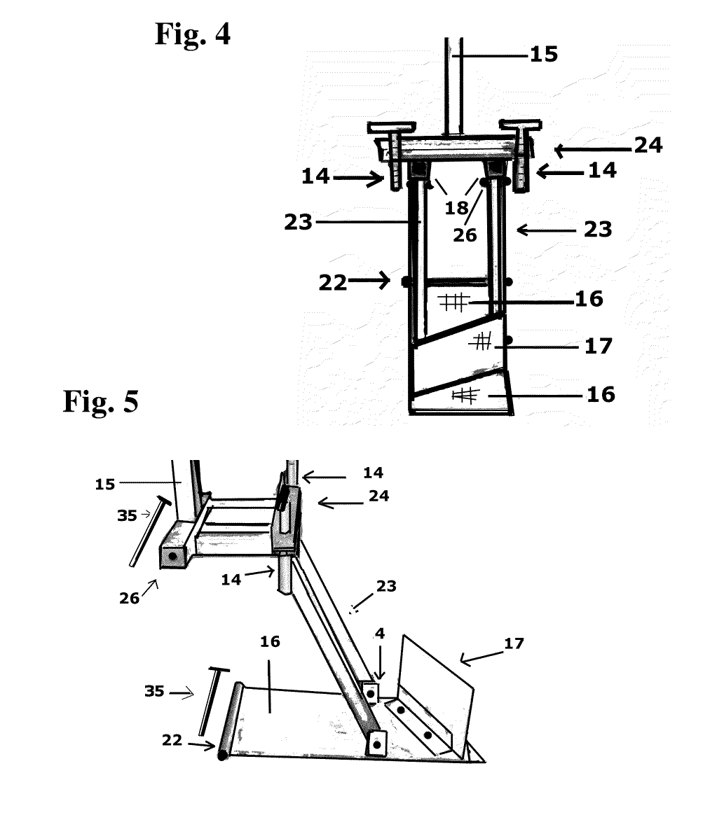

The blade is hinged from the top, (shown in FIG. 4, FIG. 5 and FIG. 9) with the front being raised and lowered so it cuts at just the right depth and angle to do the job but not more then needed so it doesn't cause extra damage the pavement surface. The unit is equipped with adjustable stops, so the blade will not go deeper then the operator wants. The operator is standing behind the handle and has full control over when to raise and lower the blade, and has full visibility of the approaching marker (TRPM). The Road CRAB can be towed behind any work truck from standard tow mount bracket.

The Road CRAB comes with two uniquely designed hitches.

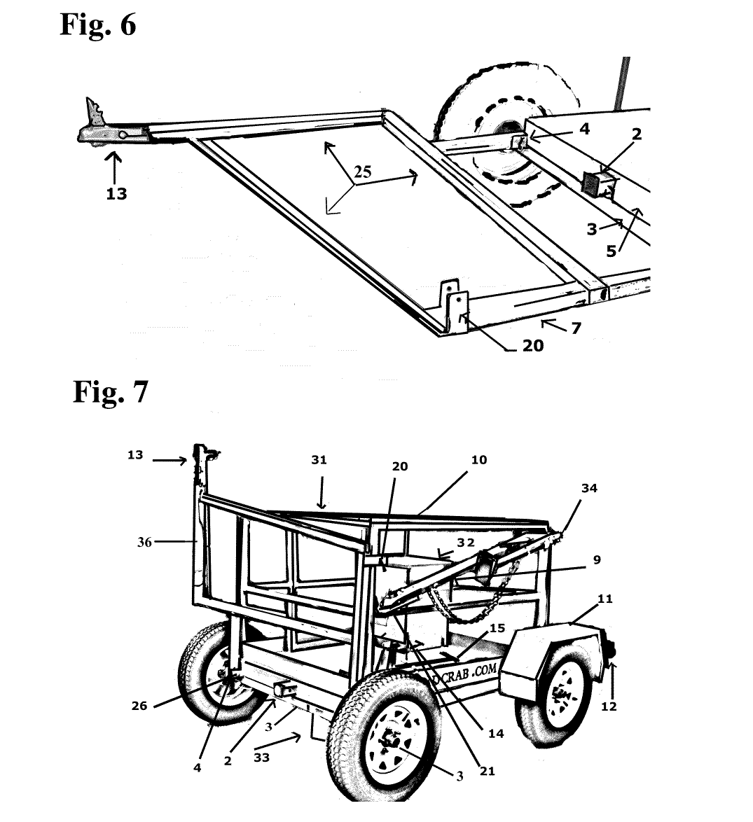

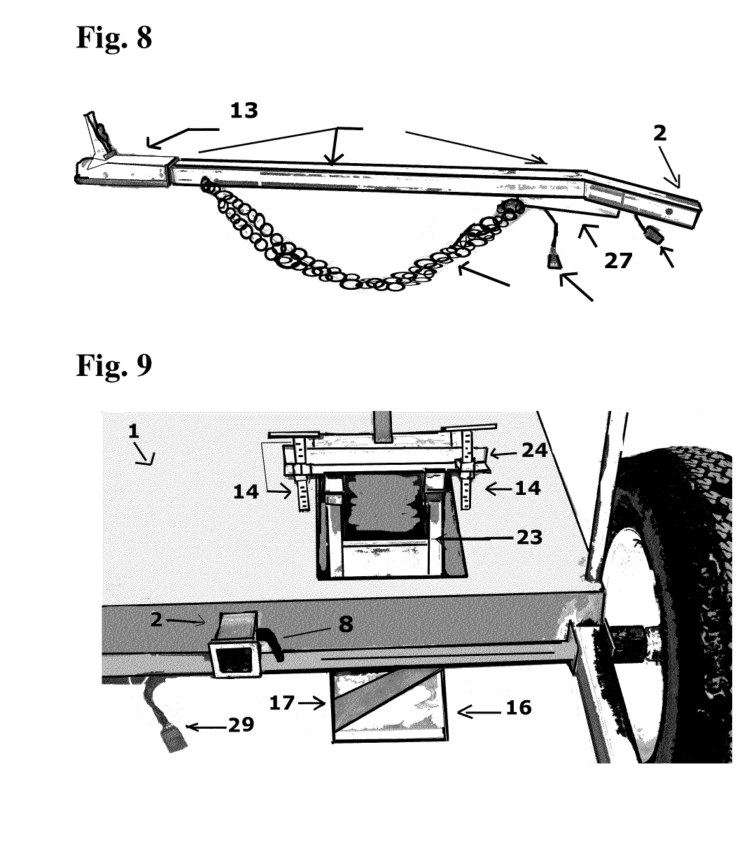

Explained below (shown in FIG. 6 and FIG. 8).

The specially designed Operational Hitch as (shown FIG. 6) for pulling off set to the driver side, with all four wheels on the ground. It allows the truck to remain in the right lane while the cutting blade is riding over the road markers on the centerline.

The blade unit it also set off to the left front side (shown in FIG. 9) of the machine to allow as little of the machine as possible to be across the centerline of the roadway when in operation this also allows the driver to see the unit and blade location and operation from the driver side mirror while in use.

This unit is also equipped with a specialty Travel Tow Hitch (shown in FIG. 8) designed with a special angle to raise the machine off the front two wheels for transport to and from job sites and allows for better maneuverability for traveling.

### BACKGROUND

I (David Greenlaw) am a contractor and welder by trade I saw a need for this machine in the industry and figured out how to build it.

### SUMMARY

This is a manually operated mechanical machine to remove road reflectors from the middle of highways and roadways. It is towed behind a standard work truck and operated by one person standing in the machine. There is no motor, and the operator raises and lowers the blade with a handle by moving it back and forth. As the machine is towed forward when the blade is lowered it slices the reflector from the road, then the blade is raised out of the way and lowered again for the next reflector.

### DRAWING DESCRIPTIONS

### Drawing Identification Numbers and Descriptions

1. Reinforced steel floor.
2. Travel Hitch connection points

### 3. Hub and Axle.

4. Pivot bracket.
5. Main machine body frame.
6. Steel support under machine.
7. Secondary framing, square tubing.
8. Hitch pins.
9. Travel Hitch. Steel square tubing.
10. Safety frame

### 11. Fender

12. Tail light
13. Standard Ball Hitch attachment (available in stores).
14. Adjustable stops, for blade depth control.
15. Control Handle to raise and lower blade.
16. Steel blade
17. Deflector shield to guide (TRPM) off to one side after removal.
18. Top blade mounting bracket.
19. Bracket to hold Travel Hitch when not in use.
20. Bracket to hold Operational Hitch upright when not in use.
21. Ball mount to hold Travel Hitch in place when not in use.
22. Back of the blade, tube to hold attachment bar.
23. Steel arms to connect blade to handle.
24. Blade assembly framing.

### 25. Operational Hitch

26. Blade assembly pivot location.

### 27. Gusset.

28. Back of blade mounting bracket/blade assembly.
29. Tow light connections
30. Safety chains
31. Door and hinges
32. Optional tool box
33. Reflector removal bar. Knocks reflectors off if stuck to blade.
34. Crank up jack stand available in stores now.
35. Attachment bar, long steel pin with handle.

### DETAILED DESCRIPTIONS

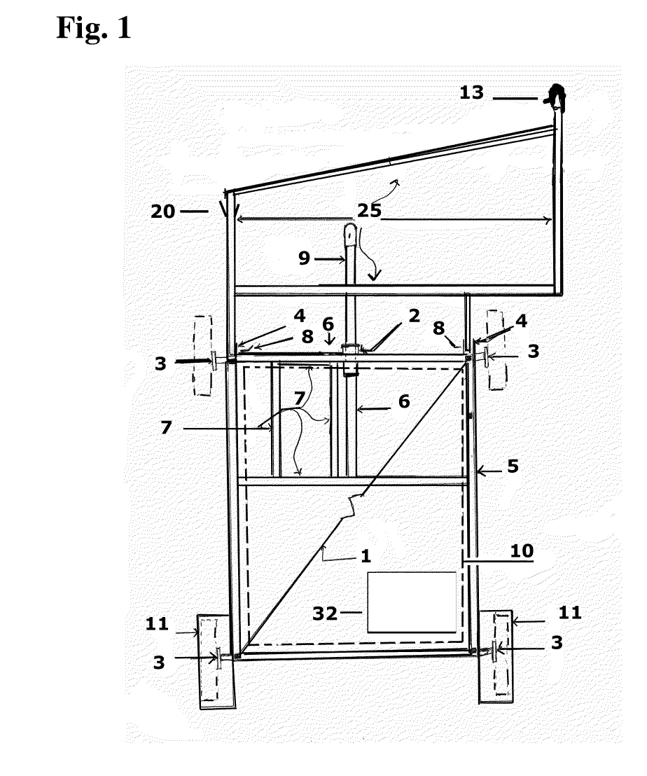

FIG. 1 Shows an overview of the Road CRAB looking down from a top position with the Travel Hitch (described as # 9 and shown FIG. 8) attached and the Operational Hitch (described as # 25 shown FIG. 6) in the down position.

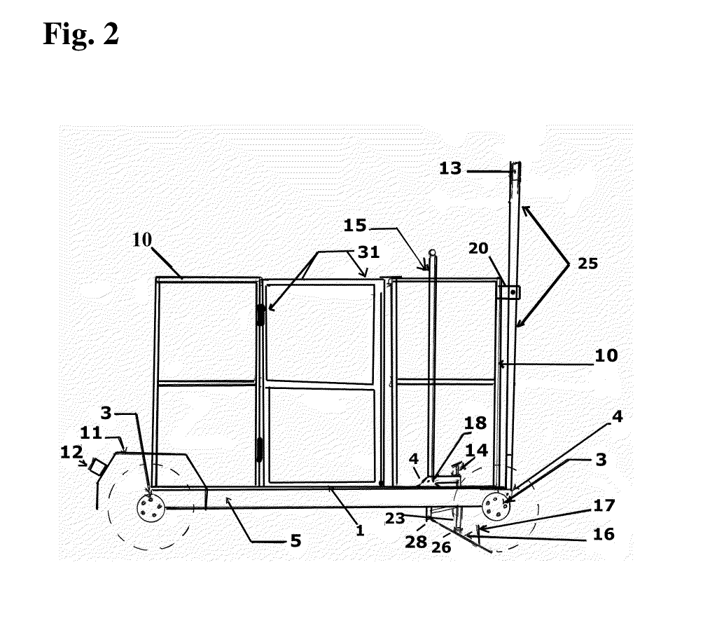

FIG. 2 Shows the entrance side view, showing the door.

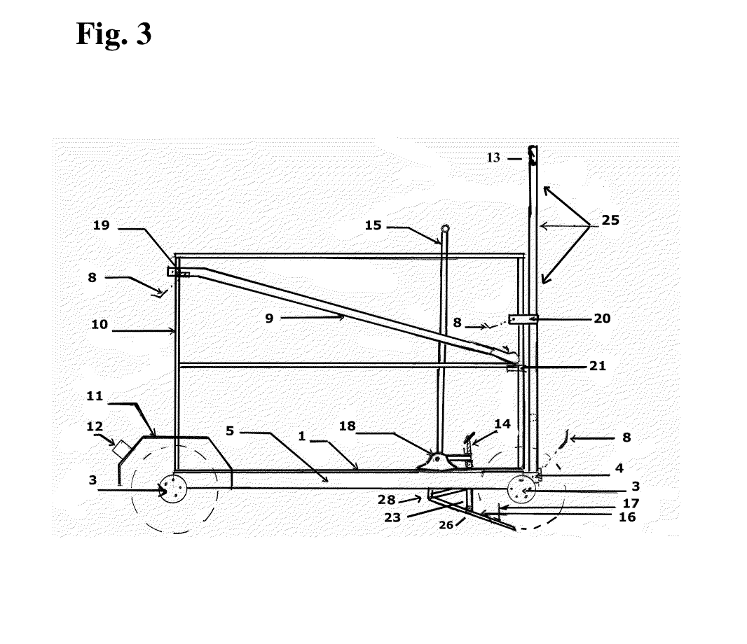

FIG. 3 The other side view, showing the storage position for both hitches and the side view for the blade in the down position

FIG. 4 This enlarged view of the blade assembly, is looking at if from the front of the blade when not in the machine. It also shows the blade adjustable stops (described as #14) and deflector shield (described as #17).

FIG. 5 Is an Enlarge blade, side view, showing the blade and its Assembly unit. Which attaches the blade to the Road CRAB machine.

FIG. 6 Is an enlarged view of our Operational Hitch in down working position. This hitch hooks to any standard work truck and off sets the machine to the driver side, so the driver in the truck can stay in the right hand lane and the blade can ride over the centerline in the road. This view shows the angles and design of this specially designed hitch. It also shows pivot points (described as # 4) they allow it to be raised out of the way when not in use.

FIG. 7 Shows the Road CRAB in its normal storage position. With both hitches in their locked storage brackets. The blade handle is lying on the deck so the blade is fully raised. This is a front and side view of the machine.

FIG. 8 This is our Travel Hitch view, when not attached to our machine. To use first attach to the front of the Road CRAB with the square end (described as #2), then use the jack showed attached in (FIG. 9) (described as # 34) to raise the entire front of the machine off the ground, then attach the front (described at # 13) to the ball hitch on the truck. Plug in the lights (described as # 29) to both the front of the machine and to the towing truck. Connect safety chains (described as # 30). This hitch turns our machine into an easy to tow two-wheeled street legal trailer. This hitch is essential to the use and operation of this machine.

FIG. 9 This is the front lower half view of the Road CRAB showing the blade and assembly in place. Also showing the Travel Hitch connection (described as # 2) and light connection (described as # 29).

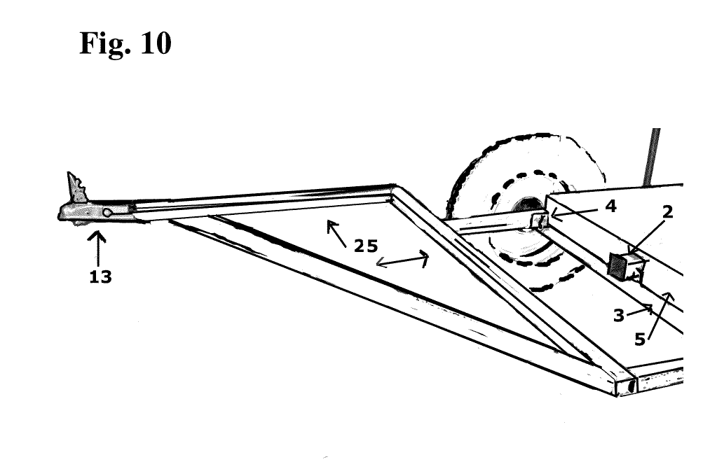

FIG. 10 This is our Alternative Operational Hitch design. It has a slightly different design then our original Operational hitch but performs the same functions as described above and (shown in FIG. 6).

1. We claim that our two specially designed hitches as (shown in FIG. 6, FIG. 8 and FIG. 10) are unique to our Road CRAB reflector removal machine and that the design and function of our blade and its connecting arms, assembly unit, and handle are also unique to our machine. The location of our blade assembly unit is also specific to this machine as it is off set from the center towards the left front wheel to allow our machines blade to be positioned over the road centerline while the majority of the machine stays in the right hand lane.
1.1. Our Travel Tow Hitch (shown in FIG. 8) has a specific downward angle near the neck of the hitch on the end that attaches to the ball on the towing truck. Which when installed to both the machine and truck raises the front two wheels of our machine off the ground. When the other end is placed into the machine the hitch angles down to the ground so when it is raised to attach to a truck for towing it forces the machine upward and supports the front of the machine while towing. This hitch has a reinforced steel gusset so it can support the weight of our machine off the ground. This turns our four-wheeled machine into a two-wheeled easily towed machine. This hitch design is unique and essential to the use of this machine. Our Road CRAB machine also has a special mounting bracket on the side of the machine for easy storage of this hitch when not in use. This hitch mounts to the bottom front and center of our machine so when in use the machine tows directly behind the towing truck. It slides into the machine with a square tubing end held in place by hitch pins and safety chains. The other end has a standard ball attachment to fit any truck ball. This hitch is also wired with a plug for lights on both sides so it can plug into the machine and into the towing truck and be completely unplugged and disconnected for storage.
1.2. Our Operational Hitch (shown in FIG. 6) and as the alternative design (shown FIG. 10), is especially designed to off set to the driver side, for operational use. With this hitch the unit has all four wheels on the ground the driver can see the operations of the unit over the center line of the road while keeping the towing truck in the right lane. It also has a special pivot design where it connects to the main frame of our machine so it can be raised out of the way and locked for travel. This pivot connection is attached to the machine in the front bottom of the frame close to both front corners. This is a three point hitch, with two swivel points permanently attached to our machine, and one ball head contact locking on to the truck. Made of square steel tubing, with cross bars and specific angles it is designed to tow the Road Crab to the left of the truck and handle the impact or jarring of hitting the road reflectors. This hitch is designed for low speed and constant impacts. This hitch is attached to the towing truck with a standard ball hitch head, which is welded on to our hitch design.

2. We claim that our blade and assembly unit (shown in FIG. 4, FIG. 5 and FIG. 9) is unique to our Road CRAB machine. It is designed to be raised and lowered using a handle that comes from the blade hanging under the machine to the operator through the floor of our machine. Our connecting braces, arms and pins allow our blade to move up and down and be easily replaced. This blade is hardened steel, sharpened on the front with a small round pipe welded on the back for the attachment bar to go through. The long round attachment bar has a handle on one end for easy removal, the other end goes through the support bracket attached to the machine, then through the back of the blade, then through the other support bracket and is locked with a cotter pin. Our blade also has an attached shield for the operator's protection. Our blade will slice and detach the road maker (TRPM) from the pavement in one movement as the machine is being pulled forward. Our assembly unit is specifically designed to handle the impact of repeatedly hitting of both the road and the reflectors. Our pivot points and pins are designed for both impact and easy blade replacement. Our blade adjustment stops are crucial as they keep the blade from gouging to deep into the road but can be adjusted up or down, as road conditions need the blade to stop higher or go deeper.
2.1 Our blade assembly unit is comprised of the following;
Hardened steel removable blade, with removable deflector shield.
Two attachment brackets bolted to the blade and the attachment arms.
Two swing arms connecting to the base of the handle and to the blade attachment brackets
The operational handle and supporting brackets.
Two long removable pins or blade attachment bars (described as # 22) with handles and cotter pins to lock it in place.
Bolts, lock washers and miscellaneous sized locking pins.
Two adjustable stops located at the base of the handle and above the machine floor as shown in (described as # 14)
2.2 This assembly can be removed from the Road CRAB as one unit with the blade attached as (shown in FIG. 4 and FIG. 5), or the blade can be removed separately by unbolting the pivot bracket (described as # 4) and removing the attachment bars (described as # 22).

3. We claim to be the original and only inventors of this machine and all aspects of its designs. After doing our own patent and industry searches we have found no product similar to our Road CRAB machine, or to it's body framing, shape and size, to our two hitches, or blade assembly. This machine has the potential to benefit a large market, both in the private road construction companies and Department of Transportation because it makes the job of removing road reflectors faster and safer than current methods.
